(19) United States
(12) Patent Application Publication
(10) Pub. No.: US 2022/0044150 A1
(43) Pub. Date: Feb. 10, 2022

(54) SYSTEMS, METHODS, AND APPARATUS TO CLASSIFY PERSONALIZED DATA

(71) Applicant: Nielsen Consumer LLC, New York, NY (US)

(72) Inventors: Kannan Balaji, Tampa, FL (US); Sedwin Vadukut, Tampa, FL (US); Sreeraman K. Krishnan, Chennai (IN); Rachel Gareau, Oldsmar, FL (US)

(21) Appl. No.: 17/394,086

(22) Filed: Aug. 4, 2021

(30) Foreign Application Priority Data
Aug. 5, 2020 (IN) 202011033521

(51) Int. Cl. G06N 20/00; G06F 16/28; G06F 16/2457

(52) U.S. Cl. CPC G06N 20/00; G06F 16/24578; G06F 16/285

(57) ABSTRACT

Methods, apparatus, systems, and articles of manufacture are disclosed herein to associate a data collector with a class by executing a classification model using a first data collector characteristic, the first data collector characteristic corresponding to the data collector, the classification model generated by applying a learning algorithm to classification training data, the classification training data including second data collector characteristics of a training group, select the class based on a requested characteristic of a task request from a distribution agent, select the data collector associated with the class, and send the selection to the distribution agent.

### RELATED APPLICATION

This patent arises from Indian Provisional Patent Application Serial No. 202011033521, which was filed on Aug. 5, 2020. Indian Provisional Patent Application No. 202011033521 is hereby incorporated herein by reference in its entirety. Priority to Indian Provisional Patent Application No. 202011033521 is hereby claimed.

### FIELD OF THE DISCLOSURE

This disclosure relates generally to computer systems and, more particularly, to computer-based personalized data classification and execution.

### BACKGROUND

Manufacturers of Consumer-Packaged Goods (CPG) often hire data collectors to study display characteristics and/or prices of their products in retail stores in a particular geographic location. In some cases, the data collectors are hired auditors, store employees, or independent that accept or reject work orders sent through manual processes by the CPG manufacturers or a consumer research entity. The work orders may involve instructions or tasks to research pricing, interview customers and employees, and/or collect images.

### BRIEF DESCRIPTION OF THE DRAWINGS

FIG. 1 is a diagram representative of an example system to classify data, provide assistance, and distribute tasks in accordance with teachings of this disclosure.

FIGS. 2A-2E are diagrams representative of example configurations of the example system of FIG. 1.

FIG. 3 is a diagram representative of an example classification system in communication with an example personalized user agent to classify data, provide assistance, and/or distribute tasks to data collectors in accordance with teachings of this disclosure.

FIG. 4 is a diagram representative of another example classification system in communication with an example personalized user agent to classify data, provide assistance, and/or distribute tasks to data collectors in accordance with teachings of this disclosure.

FIG. 5 illustrates an example system to classify data, provide assistance, and/or distribute tasks to data collectors in accordance with teachings of this disclosure.

FIG. 6 is a block diagram of an example classification agent to classify data, provide assistance, and/or distribute tasks to data collectors using machine learning in accordance with teachings of this disclosure.

FIG. 7 is a flowchart representative of machine readable instructions which may be executed to implement the classification agent of FIGS. 5 and 6 to classify data, provide assistance, and distribute tasks.

FIG. 8 is a flowchart representative of machine readable instructions which may be executed to implement the classification and distribution system of FIG. 5 to classify data, provide assistance, and distribute tasks to data collectors.

FIG. 9 is a flowchart representative of machine readable instructions which may be executed to implement the classification agent of FIGS. 5 and 6 to classify data, provide assistance, and distribute tasks to data collectors.

FIG. 10 is a flowchart representative of machine readable instructions which may be executed to implement the example classification agent of FIGS. 5 and 6 to classify data, provide assistance, and distribute tasks to data collectors.

FIG. 11 is a flowchart representative of machine readable instructions which may be executed to implement the user devices of FIG. 5 to provide training and assistance to a data collector.

FIG. 12 is a block diagram of an example processing platform structured to execute the instructions of FIGS. 7-10 to implement the classification agent of FIGS. 5 and 6.

FIG. 13 is a block diagram of an example processing platform structured to execute the instructions of FIG. 11 to implement the user devices of FIG. 5.

FIG. 14 is a block diagram of an example software distribution platform to distribute software (e.g., software corresponding to the example computer readable instructions of FIGS. 7-11) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Retailers, manufacturers, and/or consumer research entities collect data about products and/or services such as product placement in retail stores, advertisement placement, pricing, inventory, retail establishment layout, shopper traffic, vehicle traffic, etc. To request collection of such data, entities can generate task requests and hire resources (e.g., auditors) to serve as data collectors to collect such data in accordance with data collection descriptions in the task requests. Example task requests can request data collection via one or more of capturing photographs, logging data (e.g., in spreadsheets, tables, and/or other data structures), writing descriptions, answering questionnaires, etc. corresponding to product placement, advertisement placement, pricing, inventory, retail establishment layout, shopper traffic, vehicle traffic, etc. Such different types of data collection are becoming increasingly technical and can require different skills and/or data collection equipment (e.g., technologies capable of collecting and processing quantities of data beyond which is capable through human effort alone) such as a drone.

Examples disclosed herein include systems, methods, and apparatus to classify data collectors, interact with data collectors, learn data collector interests and skills based on regular interaction with the data collectors, provide training and assistance to data collectors, and/or assign tasks to data collectors based on the interests and/or skills of the data collector. As used herein, a data collector is a human that is hired, contracted, employed, and/or otherwise provides services to accept work orders for performing one or more tasks involving collecting data for use in the field of consumer research. Different skills, experiences, and interests may make some data collectors better suited for some types of tasks than others. For example, a task involving research of packaging or displays may require a higher level of photography skill than a task involving pricing research. Additionally or alternatively, a CPG client may implement requirements for hiring data collectors. For example, a CPG client may require a data collector to have a performance rating above a certain threshold for the CPG client to consider the data collector for a task. While the data collectors disclosed herein include humans, example systems, methods, apparatus, and articles of manufacture disclosed herein disclose technological solutions to improve data collector analysis, management, and allocation.

Prior techniques for processing work orders include manually recruiting data collectors, manually training data collectors, manually gathering information from data collectors, and manually assigning tasks to data collectors. Such prior techniques typically send work orders to any data collectors known in a particular location, regardless of skills, interests, or prior performance. Such manual techniques include discretionary choices by, for example, management personnel. These discretionary choices are based on “gut feel” or anecdotal experiences of the management personnel and, as such, result in inconsistencies in collected data, inefficient training, and allocation of data collectors. Furthermore, in the event selected data collectors fail to have a qualified skill sets for a work order, resources and money are wasted.

Examples disclosed herein provide substantially automated classification, training, assistance, and task assignment to data collectors by processing input data received from a digital personalized user agent associated with the data collector, assigning tasks to the data collector based on the processed input data, and providing training and/or assistance to the data collector. Examples disclosed herein eliminate the discretionary choices by humans and, thus, improve data collection efficiency and reduce errors in collected data. As a result of reducing data error, examples disclosed herein reduce computational efforts to correct erroneous data, reduce bandwidth resources that transmit and/or receive erroneous data to ultimately reduce computational waste associated with data collection.

Example input data includes data collector characteristics such as skills, skill levels, performance ratings, location, device information, and/or interests in performing particular tasks. In examples disclosed herein, the data collector characteristics are used to classify data collectors using machine learning. In some examples, a data collector is associated with a particular class based on data collector characteristics. For example, a data collector having a high photography skill level may be included in a class associated with a high photography skill level. In some examples disclosed herein, the data collector is selected from the class for a task request based on a matching characteristic and/or requirement of the task request. For example, if a task request requires a high photography skill level, then a data collector may be chosen from the class associated with a high photography skill level.

As data collector characteristics change over time, the personalized user agent associated with a data collector may use machine learning to dynamically process input data provided by the data collector, learn data collector characteristics based on the processed input data from the data collector, provide training content and guidance to the data collector, predict the behavior of a data collector based on the processed input data from the data collector, and/or accept or reject tasks based on the learned data collector characteristics. The personalized user agent may also learn and associate scores with data collectors based on skills, interests, and/or a performance rating in executing a work order with specific characteristics. The personalized user agent may update characteristics of the data collector (e.g., skills, skill level, or interests) based on completion of tasks and/or completion of training modules.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations. Additionally, AI techniques and/or technologies employed herein recognize patterns that cannot be considered by manual human iterative techniques.

Many different types of machine learning models and/or machine learning architectures exist. In examples disclosed herein, a classification model is used. Using a classification model enables a classification agent to classify data collectors based on personal attributes such as skill, performance rating, interests, and location and use these classifications to assign the data collectors to a task they are best suited for. In general, supervised learning is a machine learning model/architecture that is suitable to use in the examples disclosed herein. However, other types of machine learning models could additionally or alternatively be used, such as unsupervised learning, reinforcement learning, etc.

In general, implementing a machine learning/artificial intelligence (ML/AI) system involves two phases, a learning/training phase, and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using a nearest-neighbor algorithm. However, any other training algorithm may additionally or alternatively be used. In examples disclosed herein, training is performed at on-premise servers using hyperparameters that control how the learning is performed (e.g., a learning rate, a number of layers to be used in the machine learning model, etc.).

In examples disclosed herein, training is performed using training data. In some examples, the training data is labeled. In some examples, the training data originates from personalized user agents (e.g., personal agents) associated with data collectors. In some examples, the training data includes data collector characteristics of data collectors in a training group. For example, a training group of data collectors may provide data collector characteristics such as interests, skills, skill levels, geographic location, device information, and other information useful for assigning tasks. In some examples, a training algorithm is used to train a classification model to operate in accordance with patterns and/or associations based on, for example, the data collector characteristics provided by the training group. Once training is complete, the model is deployed for use as an executable construct that processes an input and provides an output based on the network of nodes and connections defined in the model. In some examples disclosed herein, the model is stored in a model data store and may then be executed by the model executor.

Once trained, the deployed model may be operated in an inference phase to process data. In the inference phase, data to be analyzed (e.g., live data) is input to the model, and the model executes to create an output. This inference phase can be thought of as the ML/AI “thinking” to generate the output based on what it learned from the training (e.g., by executing the model to apply the learned patterns and/or associations to the live data). In some examples, input data undergoes pre-processing (e.g., parsing) before being used as an input to the machine learning model. Moreover, in some examples, the output data may undergo post-processing after it is generated by the ML/AI model to transform the output into a useful result (e.g., a display of data, an instruction to be executed by a machine, etc.).

In some examples, output of the deployed model may be captured and provided as feedback. An accuracy of the deployed model can be determined by analyzing the feedback. If the feedback indicates that the accuracy of the deployed model is less than a threshold or other criterion, training of an updated model can be triggered using the feedback and an updated training data set, hyperparameters, etc., to generate an updated, deployed model.

In some examples, a system for assigning tasks to a user (e.g., a data collector) based on characteristics associated with the user includes a personalized user agent associated with the user to collect data from the user, receive input from the user, and learn user behavior based on the collected data and user input, a help desk agent to receive user information and requests from the personalized user agent and provide training, guidance, troubleshooting, and/or technical assistance to the user, a classification agent to receive data and information from the personalized user agent, classify the data and information using a machine learning model, and assign tasks to the user via a distribution agent, and a distribution agent to receive one or more user identifiers corresponding to one or more users suited for a particular task and submit a work order to the personalized user agent(s) associated with the user(s) for the user(s) or their personalized user agents to accept or reject.

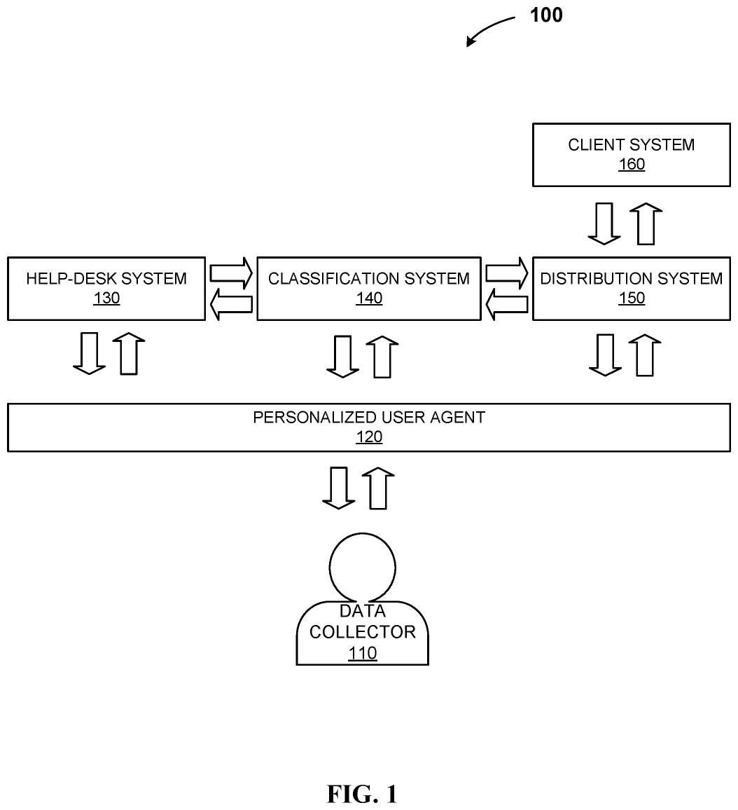

FIG. 1 is a diagram representative of an example system 100 to classify data and distribute tasks in accordance with teachings of this disclosure. The example system 100 of FIG. 1 includes an example data collector 110, an example personalized user agent 120 associated with the example data collector 110, an example help desk system 130, an example classification system 140, an example distribution system 150, and an example client system 160.

The example data collector 110 illustrated in FIG. 1 communicates with personalized user agent 120 associated with data collector 110. The personalized user agent 120 illustrated in FIG. 1 may be implemented by an example computing device (e.g., user device) used by the data collector 110. Example computing devices include, but are not limited to, a smartphone, a handheld computing device, a tablet computing device, a laptop computer, a desktop computer, or any other suitable computing device. The personalized user agent 120 communicates with the help desk system 130, classification system 140, and distribution system 150. The help desk system 130 illustrated in FIG. 1 communicates with the classification system 140 and the personalized user agent 120 associated with data collector 110. The classification system 140 illustrated in FIG. 1 communicates with the personalized user agent 120, the help desk system 130, and the distribution system 150. The distribution system 150 illustrated in FIG. 1 communicates with the personalized user agent 120, classification system 140, and client system 160.

As previously defined, a data collector (e.g., the data collector 110), as used herein, is a human being that is hired, contracted, employed, and/or otherwise provides services to accept work orders for performing one or more tasks involving collecting data for use in the technical field of consumer research. A data collector is associated with a personalized user agent that the data collector uses to accept or reject work orders and receive assignments, updates, training, and/or technical help.

The personalized user agent 120 illustrated in FIG. 1 receives input data from the data collector 110, stores the input data in memory or in a data storage device, and transmits the input data to the help desk system 130, classification system 140 and/or the distribution system 150. Example input data from the data collector 110 includes characteristics and/or attributes of the data collector 110. For example, input data may include skills, skill levels, or interests associated with the data collector 110, a geographic location of the data collector 110, device information of one or more devices used by the data collector 110 (e.g., device model, manufacturer information, camera specifications such as resolution and/or pixel size, memory and/or storage capacity, and/or other device information), and/or any other information suitable for use in assigning tasks to the data collector 110. In some examples, the personalized user agent 120 receives the input data from the data collector 110 via a user input interface. In some examples, the personalized user agent 120 processes the input data using machine learning (e.g., using machine learning algorithms). In some examples, the personalized user agent 120 interacts with the data collector 110 to seamlessly learn data collector characteristics. In some examples, the personalized user agent 120 predicts user behavior and accepts or rejects work orders based on the learned data collector characteristics.

In some examples, the personalized user agent 120 receives a work order from the distribution system 150, displays the work order to the data collector 110, and prompts the data collector 110 to accept or reject the work order. In some examples, the personalized user agent 120 receives an acceptance or rejection selection from the data collector 110 via a user input interface and transmits the selection to the distribution system 150 and the classification system 140. In some examples, the personalized user agent 120 accepts or rejects the work order automatically (e.g., without user input) based on learned data collector characteristics (e.g., the data collector is not qualified to complete the work order, etc.). In some examples, the personalized user agent 120 receives information from the classification system 140. In some examples, the personalized user agent 120 transmits queries to the help desk system 130 and receives a response to the query from the help desk system 130. In some examples, the personalized user agent 120 receives a request from the data collector 110 and transmits the request to the help desk system 130. For example, the data collector 110 may request guidance with a technical problem such as troubleshooting an application, correctly taking a picture, or any other technical issue that may arise using the personalized user agent 120. In some examples, the personalized user agent 120 receives information such as updates, training, tutorials, troubleshooting information, information for image collection, and/or other technical information from the help desk system 130.

In some examples, the help desk system 130 illustrated in FIG. 1 provides training, tutorials, guidance, updates, troubleshooting, information related to image collection, and other technical information and/or assistance to the personalized user agent 120. In some examples, the help desk system 130 provides training, tutorials, guidance, updates, troubleshooting, image collection information, and/or other technical information to the personalized user agent 120 in response to information received form the personalized user agent 120 and/or a request received from the personalized user agent 120.

In some examples, the help desk system 130 receives user information (e.g., skills, interests, location, skill level, performance ratings, and/or device information) or a request from the personalized user agent 120, identifies training content, tutorials, and/or other guidance for the user based on the user information, and provides the training content, tutorials, and/or other guidance to the personalized user agent 120 in response to the user information or request. In some examples, the help desk system 130 identifies an area of improvement (e.g., weaknesses or deficiencies) in the user's skillset based on the user information and provides customized training content to the personalized user agent 120 of the user. For example, in response to determining that a user has limited experience taking photos with a smartphone, the help desk system 130 provides photography training and/or tutorials to the user to assist the user in developing and improving their image collection skills. In some examples, the help desk system 130 receives device information from the personalized user agent 120 and customizes the tutorial to the particular device. For example, in response to determining that the data collector 110 has an iPhone 11, the help desk system 130 may provide training content for taking images on an iPhone to the personalized user agent 120.

In some examples, in response to determining that a user (e.g., the data collector 110) has a poor photography performance rating and/or a low quality rating for a particular skill, the help desk system 130 provides the user with training and/or tutorials to assist the user in improving that skill. For example, in response to determining that the user has a poor photography performance rating, the help desk system 130 may provide the user with image collection training and/or tutorials. In some examples, the help desk system 130 provides training and/or tutorials for a particular skill in response to determining that the user does not have the skill but has an interest in performing tasks requiring the skill. In some examples, the training evolves as the user's skill, experience, and interests evolve. For example, as a user advances a skill level, the training content may become more advanced and/or may change to address a known weakness in a skill level.

In some examples, the help desk system 130 evaluates a user's work product (e.g., photos, written descriptions, data entries, or other work product collected for a task) and identifies areas of improvement based on a determined quality of the work product. For example, the help desk system 130 may analyze a photo taken by the user for a task, calculate a quality score for the image, and determine whether to provide the user with image collection training based on the quality score. In some examples, the help desk system 130 calculates a score for one or more characteristics of a photo taken by the user for a task. For example, the help desk system 130 may calculate a score for positioning, alignment, lighting, blur, overall clarity, or other characteristic of the image (e.g., an image of a product, a display, a price tag, or other object). In some examples, the help desk system 130 compares the characteristic score to a threshold value to determine whether to provide the user with training content. In some examples, the help desk system 130 identifies an area of improvement based on the characteristic score(s). For example, the help desk system 130 may evaluate a photo taken by a user, calculate an alignment score (e.g., determine how well an object is aligned in the image), compare the alignment score to a threshold value, determine the alignment score is less than the threshold value, and provide alignment guidance, training modules, and/or tutorials to the user.

In some examples, the help desk system 130 identifies an area of improvement and provides guidance to the user while the user is performing a task involving the area of improvement. For example, if the help desk system 130 determines the user has a low alignment score, the help desk system may identify photo alignment as an area of improvement and assist the user in taking a photo by enabling photo assist features (e.g., object detection, guide boxes, and/or other photo assist features) in an application and/or on the device camera.

In some examples, the help desk system 130 updates and/or prompts the personalized user agent 120 to update a user skill and/or a user skill level in response to determining the user has completed a training module or tutorial. In some examples, the help desk system 130 provides an indication to the classification system 140 that the user has completed a training module or tutorial. In some examples, the classification system 140 updates a classification of the user based on the indication from the help desk system 130 that the user completed training content, added a skill, and/or increased in skill level. For example, in response to receiving an indication that the user has completed photography training, the classification system 140 may associate the user with a class having photography skills or an improved level of photography skills compared to before completing the training.

In some examples, the help desk system 130 provides updates, troubleshooting, information related to image collection, and/or other technical information to the personalized user agent 120. In some examples, the help desk system 130 provides updates, troubleshooting, image collection information, and/or other technical information to the personalized user agent 120 in response to a request from the personalized user agent 120. In some examples, the help desk system 130 accesses a data collector characteristic such as location information, device information, and/or other information from the personalized user agent 120. For example, the example help desk system 130 may access information about a camera of a device associated with the example personalized user agent 120 (e.g., resolution, pixel size, and/or optical or digital zoom) and/or a software version of the device and/or a particular application (e.g., a data collection application). In some examples, the help desk system 130 assists with a request from the personalized user agent 120 based on the accessed information. For example, the help desk system 130 may provide the user with tutorials and/or guidance for taking photos with the camera in response to determining that the device camera has poor specifications. In some examples, the help desk system 130 prompts the personalized user agent 120 to update one or more applications in response to determining that the personalized user agent 120 has an out-of-date version of the application(s).

In some examples, the help desk system 130 receives information from the classification system 140. In some examples, the help desk system 130 receives classification information from the classification system 140. In some examples, the help desk system 130 associates training content, tutorials, guidance, and/or other content with a class and provides the training, tutorials, guidance, and/or other content to the personalized user agent 120 of a user associated with the class. For example, the help desk system 130 may associate image collection training with a class having limited photography skills and/or a class having devices with poor camera specifications and provide photography training, tutorials, guidance, and/or other content to an example personalized user agent 120 of a user within the class. In some examples, the help desk system 130 notifies the classification system 140 that a user has completed training content, added a skill, and/or increased a skill level, and, in response to the notification, the classification system 140 may update a classification based on the completed training content, added skill, and/or increased skill level. For example, in response to receiving a notification from the help desk system 130 that the user completed photography training, added a photography skill, and/or increased a photography skill level, the classification system 140 may associate the user with a class having photography skills when subsequent tasks are assigned.

The classification system 140 illustrated in FIG. 1 receives data from the personalized user agent 120 associated with the data collector 110. For example, the classification system 140 may receive data collector characteristics, such as a skill of the data collector 110, a skill level, a performance rating, one or more interests, a location, and/or device information of one or more devices used by the data collector 110 (e.g., device model, manufacturer information, camera specifications such as resolution and/or pixel size, memory and/or storage capacity, and/or other device information). In some examples, the classification system 140 regularly samples and/or interacts with the personalized user agent 120 to associate training content, work order interests, and/or other content with various classes and/or to identify training content, work order interests, and/or other content corresponding to the class associated with the personalized user agent 120. In some examples, the classification system 140 transmits information to the personalized user agent 120. In some examples, the classification system 140 sends training content, work order interest information, and/or other content to the personalized user agent 120 by associating the example personalized user agent 120 to a class. In some examples, the classification system 140 associates the personalized user agent 120 to a class based on data collector characteristics of the data collector 110 associated with the personalized user agent 120. In some examples, the classification system 140 associates the personalized user agent 120 to a class using a nearest-neighbor method or other suitable method, e.g., logistic regression, decision tree, or neural network.

In some examples, the classification system 140 assigns the data collector 110 to a class based on data received from the personalized user agent 120 of the data collector 110, selects the data collector 110 from the class in response to a task request, and transmits identifying information associated with the data collector 110 to the distribution system 150. In some examples, the classification system 140 receives an indication of acceptance or rejection of a work order from the distribution system 150, stores the indication of acceptance or rejection in memory, and/or updates the information associated with the data collector 110 based on the indication of acceptance or rejection. For example, the classification system 140 may update a classification model based on the indication of acceptance or rejection. In some examples, the classification system 140 receives information from the help desk system 130, such as device information and/or specifications of the personalized user agent 120 associated with the data collector 110 or other information associated with the data collector 110.

The example distribution system 150 illustrated in FIG. 1 receives a task request from the client system 160 (e.g., a system of a CPG manufacturer searching to hire a data collector) and generates a work order based on the task request. In some examples, the task request is associated with a characteristic and/or requirement of a task (e.g., a location and/or skill level). In some examples, the distribution system 150 transmits the work order to the classification system 140, receives identifying information associated with the data collector 110 from the classification system 140, and transmits the work order to the personalized user agent 120 of the data collector 110. In some examples, the distribution system 150 receives an indication of acceptance or rejection of the work order from the personalized user agent 120, transmits the indication of acceptance or rejection of the work order to the classification system 140, and, in response to receiving an indication of acceptance, the distribution system 150 generates an assignment based on the work order and transmits the assignment to the personalized user agent 120 of the data collector 110. In some examples, the assignment includes further details associated with the task. For example, the assignment may include further details and/or instructions relating to the task, such as a location of a store where data is to be collected, dress code requirements, a pay rate, behavior expectations, and/or criteria associated with the task, and/or any other information related to the task.

In some examples, the classification system 140 updates a data collector characteristic of the data collector 110 based on an indication of acceptance or rejection of the work order. For example, if the personalized user agent 120 rejects a work order for a retail task, the classification system 140 may update an interest characteristic of the data collector 110 to reflect that the data collector 110 may not have an interest in performing retail tasks. Accordingly, the classification system 140 may be less likely to choose the data collector 110 for a retail task in the future. In some examples, the classification system 140 updates a class associated with the data collector 110 based on acceptance or rejection of a task. For example, if the classification system 140 receives a rejection from the personalized user agent 120 for a retail task, the classification system 140 may remove the data collector 110 from a class of data collectors having an interest in retail tasks.

The personalized user agent 120, the help desk system 130, the classification system 140, and the distribution system 150 may be arranged to communicate with multiple other user devices, help desk systems, classification systems, distribution systems and/or other systems not described herein.

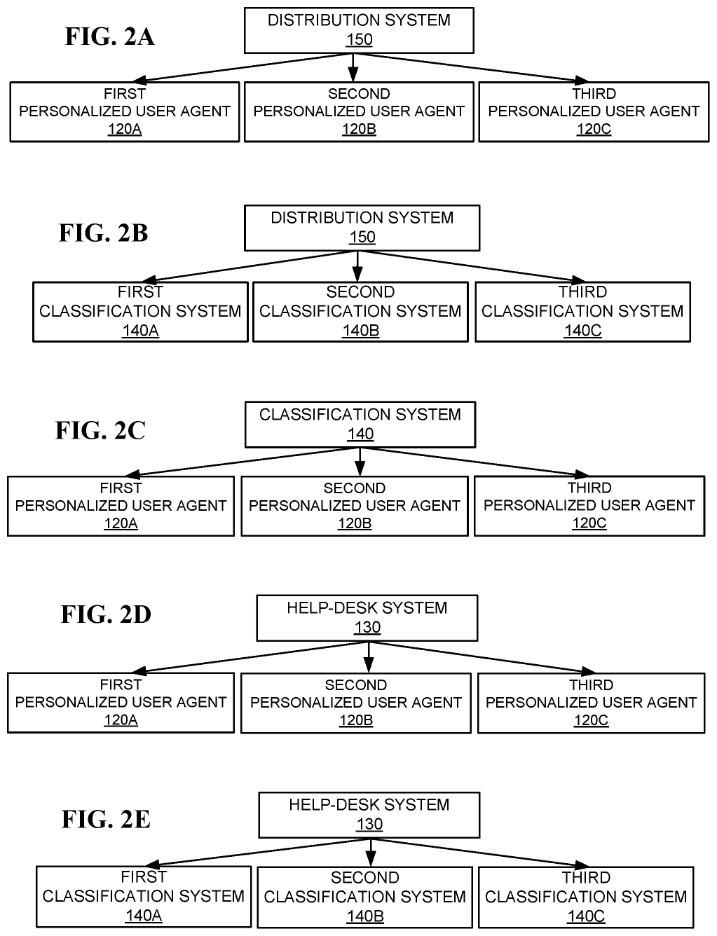

FIGS. 2A-2E are representative of example configurations of the example system 100 illustrated in FIG. 1. As shown in FIGS. 2A-2E, the help desk system 130, the classification system 140, and/or the distribution system 150 may be arranged to communicate with multiple example personalized user agents 120a-c and/or classification systems 140a-c.

As shown in the example diagram of FIG. 2A, the distribution system 150 of FIG. 1 may communicate with more than one personalized user agent 120. For example, in FIG. 2A, the distribution system 150 communicates with a first personalized user agent 120a, a second personalized user agent 120b, and/or a third personalized user agent 120c.

As shown in the example diagram of FIG. 2B, the distribution system 150 of FIG. 1 may communicate with more than one classification system 140 depending on geography, work order characteristics, and/or other factors. For example, in FIG. 2B, the distribution system 150 communicates with a first classification system 140a, a second classification system 140b, and/or a third classification system 140c.

As shown in the example diagram of FIG. 2C, the classification system 140 of FIG. 1 may communicate with more than one personalized user agent 120. For example, in FIG. 2C, the classification system 140 communicates with a first personalized user agent 120a, a second personalized user agent 120b, and/or a third personalized user agent 120c.

As shown in the example diagram of FIG. 2D, the help desk system 130 of FIG. 1 may communicate with more than one personalized user agent 120. For example, in FIG. 2D, the help desk system 130 communicates with a first personalized user agent 120a, a second personalized user agent 120b, and/or a third personalized user agent 120c.

As shown in the example diagram of FIG. 2E, the help desk system 130 of FIG. 1 may communicate with more than one classification system 140 depending on geography, work order characteristics, and/or other factors. For example, in FIG. 2E, the help desk system 130 communicates with a first classification system 140a, a second classification system 140b, and/or a third classification system 140c.

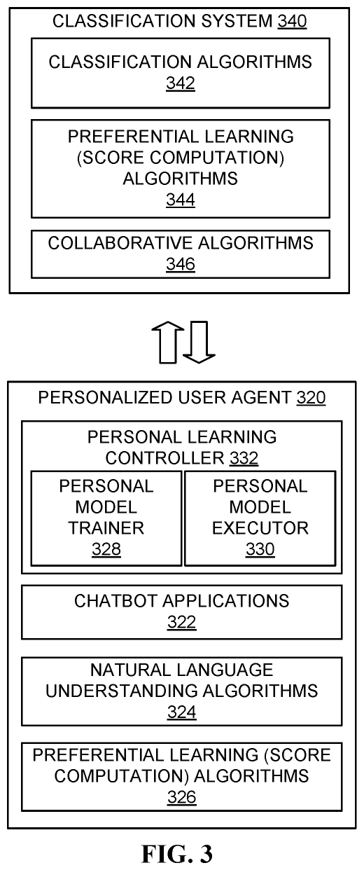

FIG. 3 illustrates an example personalized user agent 320 (e.g., a personal agent) in communication with an example classification system 340 (e.g., a classification agent). The personalized user agent 320 may be used to implement the personalized user agent(s) 120 of FIGS. 1, 2A, 2C, and 2E. The classification system 340 may be used to implement the classification system 140 of FIGS. 1, 2B, 2C, and 2E. In the example illustrated in FIG. 3, the classification system 340 communicates with the personalized user agent 320 to receive data from the personalized user agent 320 associated with a data collector (e.g., the data collector 110 of FIG. 1). For example, the classification system 340 may receive characteristics of the data collector 110 such as skills of the data collector 110, skill level of the data collector 110, interests of the data collector 110, a geographic location of the data collector 110, performance ratings of the data collector 110, device information associated with the data collector 110, and/or any other information suitable for use in assigning tasks to the data collector 110. In some examples, the classification system 340 provides information about content and/or preferences of other personalized user agents in communication with the classification system 340 to the personalized user agent 320.

In the example illustrated in FIG. 3, the classification system 340 includes one or more classification algorithms 342 to classify a data collector (e.g., the data collector 110 of FIG. 1) associated with the personalized user agent 320 based on data collector characteristics received from the personalized user agent 320.

In the example illustrated in FIG. 3, the classification system 340 includes one or more preferential learning (score computation) algorithms 344 to identify training content, work order interests, and other content by sampling and interacting with the personalized user agent 320 in regular intervals.

In the example illustrated in FIG. 3, the classification system 340 includes one or more collaborative algorithms 346 to associate training content, work order interests, and/or other content with a class generated by the classification system 340. In some examples, the one or more collaborative algorithms 346 include a nearest-neighbor method or other suitable method.

In the example illustrated in FIG. 3, the personalized user agent 320 includes one or more example chatbot applications 322 and one or more natural language understanding algorithms 324 to interact with the corresponding data collector 110 (FIG. 1) to learn interests, skills, and/or other information about the data collector 110. In some examples, the chatbot applications 322 communicate in different spoken languages. For example, the chatbot applications 322 may communicate with the data collector 110 in English, Spanish, Chinese, French, Hindi, and/or any other language. The personalized user agent 320 of FIG. 3 includes one or more preferential learning algorithms 326 (e.g., score computation algorithms) to analyze and interpret the interests of the data collector 110, skills of the data collector 110, and other information about the data collector 110.

In some examples, the personalized user agent 320 includes an example personal learning controller 332 to analyze and understand input from the data collector 110 and predict data collector characteristics based on the input. In some examples, the personal learning controller 332 includes an example personal model trainer 328 and example personal model executor 330. In some examples, the personal model trainer 328 applies an algorithm (e.g., a personal learning algorithm) to first input from the data collector 110 (e.g., training data), and the personal model executor 330 executes a personalized model based on second input from the data collector 110.

In some examples, the personalized user agent 320 illustrated in FIG. 3 invokes the classification system 340 to obtain information on content and preferences of other similar personalized user agents in communication with the classification system 340. In some examples, the classification system 340 provides the requested information to the personalized user agent 320.

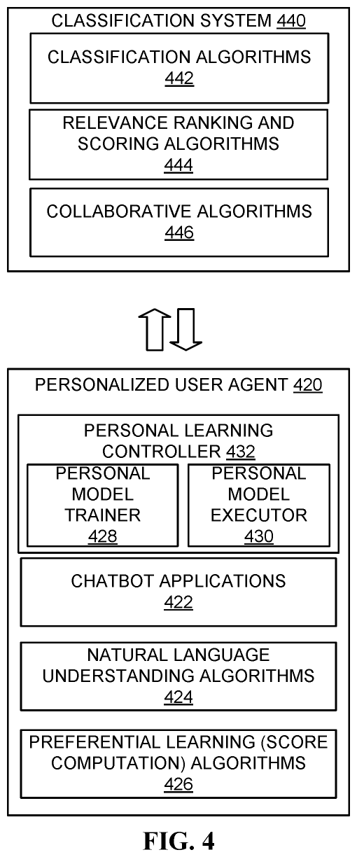

FIG. 4 illustrates another example personalized user agent 420 (e.g., an example personal agent) in communication with another example classification system 440 (e.g., an example classification agent). The personalized user agent 420 may be used to implement the personalized user agent(s) 120 of FIGS. 1, 2A, 2C, and 2D. The classification system 440 may be used to implement the classification system 140 of FIGS. 1, 2B, 2C, and 2D. In the example illustrated in FIG. 4, the classification system 440 communicates with the personalized user agent 420 to provide information to the personalized user agent 420 about query content of other personalized user agents in communication with the classification system 440.

In the example illustrated in FIG. 4, the classification system 440 includes one or more classification algorithms 442 to classify a data collector 110 (FIG. 1) associated with various personalized queries, data collector characteristics, device characteristics, geographic location, or other information.

In the example illustrated in FIG. 4, the classification system 440 includes one or more relevance ranking and scoring algorithms 444 to analyze queries and identify query content by sampling and/or interacting with the personalized user agent 420 at regular intervals.

In the example illustrated in FIG. 4, the classification system 440 includes one or more collaborative algorithms 446 to associate query content to a class generated by the classification system 440. In some examples, the one or more collaborative algorithms 446 include a nearest-neighbor method and/or other suitable methods.

In the example illustrated in FIG. 4, the personalized user agent 420 includes one or more chatbot applications 422 and one or more natural language understanding algorithms 424 to interact with the data collector 110 (FIG. 1) associated with personalized user agent 420 and learn interests of the data collector 110, skills of the data collector 110, and/or the information about the data collector 110. In some examples, the chatbot applications 422 communicate in different spoken languages. For example, the chatbot applications 422 may communicate with the data collector 110 in English, Spanish, Chinese, French, Hindi, or any other language.

The example personalized user agent 420 of FIG. 4 includes one or more preferential learning (score computation) algorithms 426 to guide the data collector 110 and provide a quick response to queries from the data collector 110.

In some examples, the personalized user agent 420 includes a personal learning controller 432 to analyze and understand input from the data collector 110 and predict data collector characteristics based on the input. In some examples, the personal learning controller 432 includes an example personal model trainer 428 and an example personal model executor 430. In some examples, the personal model trainer 428 applies an algorithm (e.g., a personal learning algorithm) to first input from the data collector 110 (e.g., training data) and the personal model executor 430 executes a personalized model based on second input from the data collector 110.

In some examples, the personalized user agent 420 illustrated in FIG. 4 invokes the classification system 440 to obtain information on query content and preferences of other similar personalized user agents in communication with the classification system 440. In some examples, the classification system 440 provides the requested information to the personalized user agent 420.

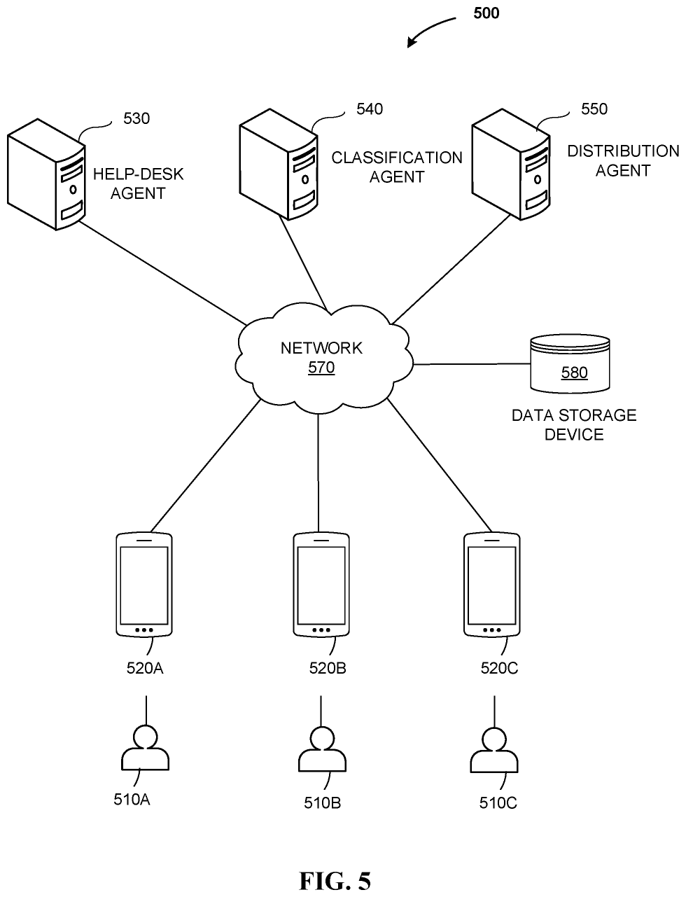

FIG. 5 illustrates an example system 500 to classify data, provide assistance, and distribute tasks in accordance with teachings of this disclosure. In the illustrated system 500 of FIG. 5, example data collectors 510a-c and respective example user devices 520a-c are in communication with an example help desk agent 530, an example classification agent 540, and an example distribution agent 550 via a network 570. In some examples, the example help desk agent 530, the example classification agent 540, and the example distribution agent 550 may implement the example help desk system 130, the example classification system 140, and/or the example distribution system 150 illustrated in FIG. 1, respectively. In the example illustrated in FIG. 5, each data collector 510a, 510b, and 510c is associated with a respective user device 520a, 520b, and 520c. For example, data collector 510a is associated with user device 520a, data collector 510b is associated with user device 520b, and data collector 510c is associated with a user device 520c.

The user devices 520a-c may implement corresponding personalized user agents such as the personalized user agents 120 (FIGS. 1 and 2), 320 (FIG. 3), and/or 420 (FIG. 4). The user devices 520a-c may be any combination of smartphones, tablets, and/or any other suitable device capable of processing and transmitting data. In some examples, a user device 520a-c includes a data interface, a processor, and a memory. In some examples, a user device 520a-c is capable of processing data using machine learning. In some examples, a user device 520a-c includes an example personal model trainer and an example personal model executor to process data using machine learning, e.g., by applying a machine learning algorithm to first input data (e.g., personal training data) and executing a personal model based on second input data.

The example system 500 illustrated in FIG. 5 includes an example data storage device 580 to store data received from the user device 520a-c, the help desk agent 530, the classification agent 540, and/or the distribution agent 550.

In the example system 500 illustrated in FIG. 5, the help desk agent 530, the classification agent 540, and/or the distribution agent 550 are each implemented on separate servers. In some examples, the help desk agent 530, the classification agent 540, and/or the distribution agent 550 are implemented on one or more servers. In some examples, a combination of a help desk agent 530, a classification agent 540, and/or a distribution agent 550 are implemented on a single server. In some examples, one or more of the help desk agent 530, the classification agent 540, and/or the distribution agent 550 are located on-premise, for example, at the site of a CPG manufacturer or consumer research entity.

In the example system 500 illustrated in FIG. 5, the user devices 520a-c are implemented on separate devices. In such examples, each device is associated with a corresponding data collector 510a-c. In some examples, one of the data collectors 510a-c and respective user devices 520a-c are in the same or a different geographic location than other ones of the data collectors 510a-c and respective user devices 520a-c. For example, the data collector 510a and the corresponding user device 520a may be in the same or a different geographic location (e.g., the same store, warehouse, etc.) as the data collector 510b and the corresponding user device 520b, and the data collector 510b and the corresponding user device 520b may be in the same or a different geographic location than the data collector 510c and the corresponding user device 520c.

In some examples, the user devices 520a-c learn and associate scores with the respective data collectors 510a-c based on skills and interests of the data collectors 510a-c. For example, the data collectors 510a-c may be assigned a score that reflects the interests and skills of the respective data collector 510a, 510b, 510c in executing a work order with a characteristic. For example, the data collector 510a may have a strong interest and skill level in photography, and thus, may be associated with a high score in photography. The data collector 510b may have strong interpersonal skills and enjoy talking to people, and thus, data collector 510b may be associated with a high interpersonal score. The data collector 510c may have excellent performance ratings, and thus, may be associated with a high reliability and/or performance score.

In some examples, a score associated with a respective data collector 510a-c, may be a combination of sub-scores related to interests of the data collector 510a-c, skills of the data collector 510a-c, and/or other information about the data collector 510a-c. The score associated with a respective data collector 510a-c may be used to classify the data collector 510a-c and determine which type of task is best suited for the data collector 510a-c.

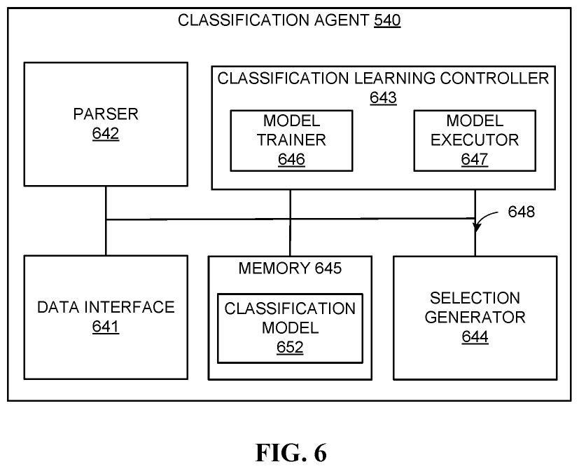

FIG. 6 is a block diagram of the example classification agent 540 illustrated in FIG. 5 to process and classify information received from a user device 520a-c using machine learning. The classification agent 540 illustrated in FIG. 6 includes an example data interface 641, an example parser 642, an example classification learning controller 643, an example selection generator 644, and an example memory 645. In the illustrated example, the data interface 641, the parser 642, the classification learning controller 643, the selection generator 644, and the memory 645 are connected via a bus 648.

In the illustrated example of FIG. 6, the example data interface 641 receives information of a data collector (e.g., example data collector 510a-c illustrated in FIG. 5) from a respective personalized user agent (e.g., example user device 520a-c illustrated in FIG. 5). In some examples, the information is a data collector characteristic. For example, the data collector characteristic may be a skill level of the data collector 510a-c, a performance rating of the data collector 510a-c, one or more interests of the data collector 510a-c, a location associated with the data collector 510a-c, or device information associated with the user devices 520a-c of the data collector 510a-c. The data interface 641 illustrated in FIG. 6 receives a work order or request from a distribution agent (e.g., the distribution agent 550 illustrated in FIG. 5). In some examples, the work order or request is associated with task having a characteristic. For example, the task may be a retail-based task, electronic-based task, photography-based task, or other task having a characteristic. In some examples, the data interface 641 receives information from a help desk agent (e.g., the help desk agent 530 illustrated in FIG. 5). In some examples, the information from the help desk agent 530 is technical and/or device information in general and/or related to a specific data collector 510a-c. In some examples, the data interface 641 receives a query from the user device 520a-c and/or the help desk agent 530 along with information that may be used to resolve the query. In some examples, the data interface 641 transmits a response to the query to the user device 520a-c and/or help desk agent 530.

In the illustrated example of FIG. 6, the parser 642 parses the information received from a user device 520a-c, the distribution agent 550, the help desk agent 530, and/or a client system (e.g., the client system 160 illustrated in FIG. 1). In some examples, the parser 642 parses the information by correcting errors in the information, converting the information into a readable data format, removing outliers from the information, and/or removing duplicate data from the information.

In the illustrated example of FIG. 6, the classification learning controller 643 receives the information from the parser 642 and classifies a data collector 510a-c based on the information. In some examples, the classification learning controller 643 implements machine learning techniques to classify the data collector 510a-c. In the illustrated example of FIG. 6, the classification learning controller 643 includes a model trainer 646 to apply a learning and/or training algorithm to the classification training data. In some examples, the classification training data is based on data collector characteristics of a training group of data collectors. In some examples, the learning algorithm is a classification algorithm, a preferential learning algorithm, a relevance ranking and scoring algorithm, a collaborative algorithm, and/or any other suitable machine learning algorithm.

The classification learning controller 643 illustrated in FIG. 6 includes an example model executor 647 to execute an example classification model 652 based on the algorithm applied to the information by the model trainer 646. The model executor 647 classifies the data collectors 510a-c based on the information (e.g., skill level of a data collector, performance rating of a data collector, one or more interests of a data collector, a location of a data collector, device information of the data collector, and/or a score or ranking associated with the data collector). For example, the model executor 647 may classify the data collectors 510a-c based on high performance ratings, technical capability, and/or location.

In the illustrated example of FIG. 6, the selection generator 644 receives a task request from the distribution agent 550. The selection generator 644 selects data collector 510a-c from a class generated by the classification learning controller 643 based on one or more characteristics (e.g., attributes, requirements, etc.) of the task. For example, the task may have a location requirement (e.g., Boston, Mass.), and the selection generator 644 may select a data collector 510a-c from a class based on the location requirement (e.g., a class of data collectors located in Boston, Mass.). Some tasks may have urgency attributes accompanied by date/time information for task completion. Some tasks may indicate skills needed by a data collector to perform the task. In some examples, the selection generator 644 selects a list of data collectors 510a-c from a class. In the example illustrated in FIG. 6, the selection generator 644 transmits the selection to the distribution agent 550. In some examples, the selection generator 644 receives a query from the data interface 641, selects a class in response to receiving the query, and assigns a data collector 510a-c to the selected class.

The classification agent 540 illustrated in FIG. 6 includes memory 645 to store information, e.g., data collector characteristics, received from one or more data collectors 510a-c, information parsed by the parser 642, various learning algorithms, and/or various classification models (e.g., the classification model 652).

While an example manner of implementing the classification agent 540 of FIG. 5 is illustrated in FIG. 6, one or more of the elements, processes and/or devices illustrated in FIG. 6 may be combined, divided, re-arranged, omitted, eliminated and/or implemented in any other way. Further, the data interface 641, the parser 642, the classification learning controller 643, the selection generator 644, the model trainer 646, the model executor 647, the classification model 652, and/or, more generally, the classification agent 540 of FIG. 6 may be implemented by hardware, software, firmware and/or any combination of hardware, software and/or firmware. Thus, for example, any of the data interface 641, the parser 642, the classification learning controller 643, the selection generator 644, the model trainer 646, the model executor 647, the classification model 652, and/or, more generally, the classification agent 540 of FIG. 6 could be implemented by one or more analog or digital circuit(s), logic circuits, programmable processor(s), programmable controller(s), graphics processing (s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the data interface 540, the parser 642, the classification learning controller 643, the selection generator 644, the model trainer 646, the model executor 647, the classification model 652 is/are hereby expressly defined to include a non-transitory computer readable storage device or storage disk such as a memory, a digital versatile disk (DVD), a compact disk (CD), a Blu-ray disk, etc. including the software and/or firmware. Further still, the classification agent 540 of FIG. 6 may include one or more elements, processes and/or devices in addition to, or instead of, those illustrated in FIG. 6, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

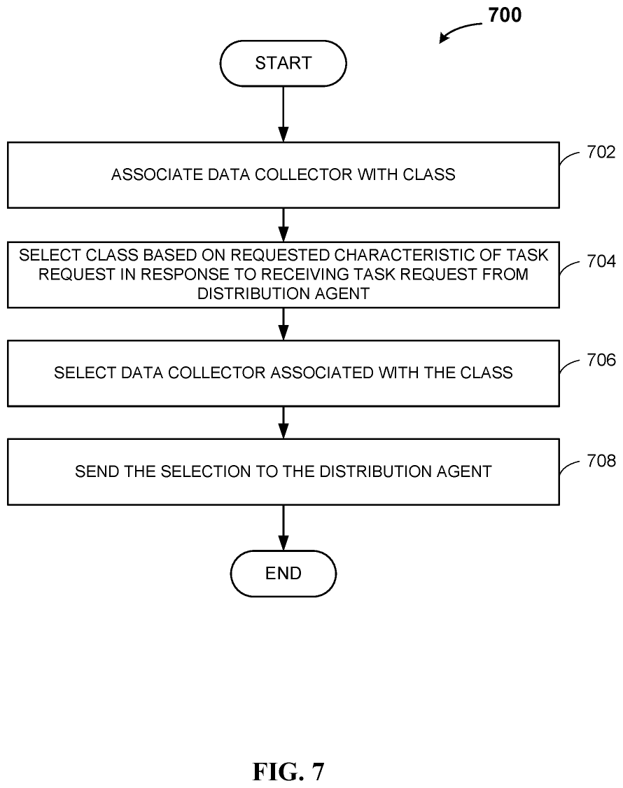

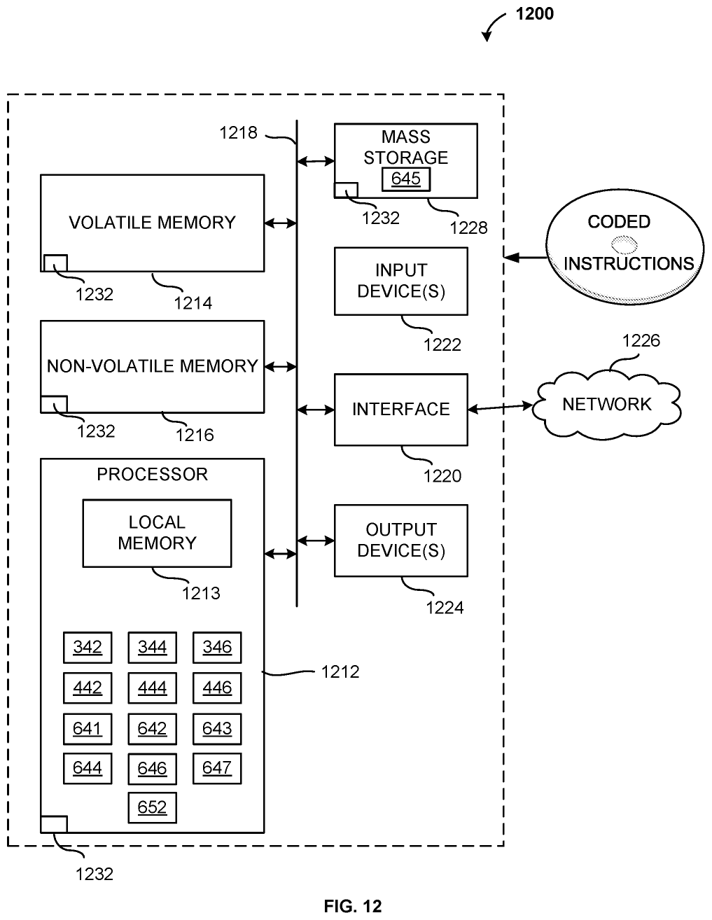

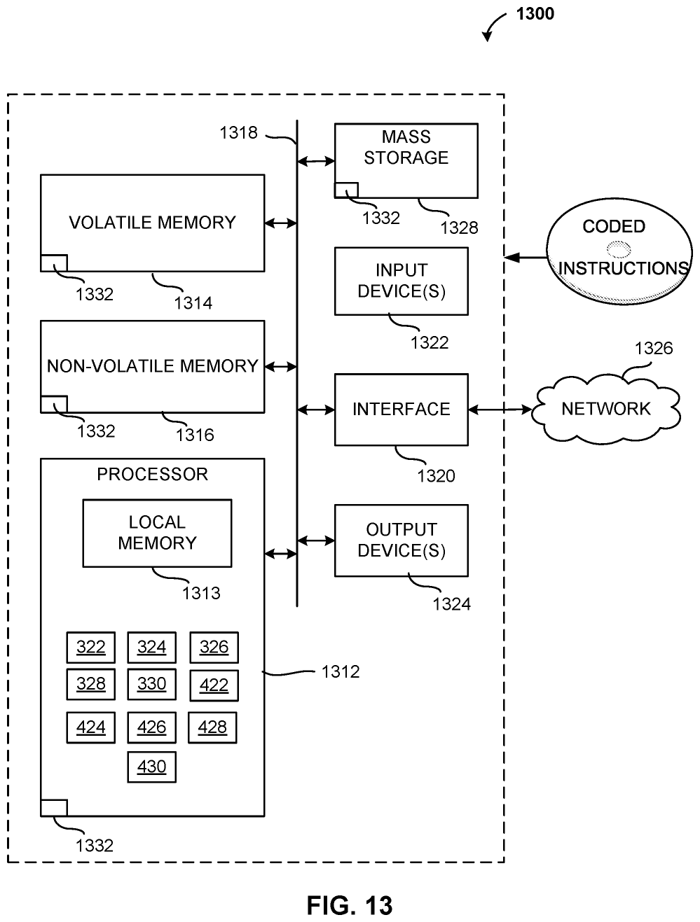

Flowcharts representative of example hardware logic, machine readable instructions, hardware implemented state machines, and/or any combination thereof for implementing the personalized user agent 120, the help desk system 130, the classification system 140, and/or the distribution system 150 of FIG. 1 and the user devices 520a-c, the help desk agent 530, the classification agent 540, and/or the distribution agent 550 of FIGS. 5 and 6 are shown in FIGS. 7-11. The machine readable instructions may be one or more executable programs or portion(s) of an executable program for execution by a computer processor and/or processor circuitry, such as the processor 1212 shown in the example processor platform 1200 and/or the processor 1312 shown in the example processor platform 1300 discussed below in connection with FIGS. 12 and 13, respectively. The program(s) may be embodied in software stored on a non-transitory computer readable storage medium such as a CD-ROM, a floppy disk, a hard drive, a DVD, a Blu-ray disk, or a memory associated with the processor 1212 and/or the processor 1312, but the entire program(s) and/or parts thereof could alternatively be executed by a device other than the processor 1212 and/or the processor 1312 and/or embodied in firmware or dedicated hardware. Further, although the example program(s) is described with reference to the flowcharts illustrated in FIGS. 7-11, many other methods of implementing the example personalized user agent 120, the example help desk system 130, the example classification system 140, the example distribution system 150, the example user devices 520a-c, the example help desk agent 530, the example classification agent 540, and/or the example distribution agent 550 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example processes of FIGS. 7-11 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single or processor. Additionally, although individual features may be included in different examples or claims, these may possibly be combined, and the inclusion in different examples or claims does not imply that a combination of features is not feasible and/or advantageous.

The example program 700 of FIG. 7 may be executed to implement the example classification agent 540 of FIGS. 5 and 6 to assign tasks to the example data collectors 510a, 510b, 510c (FIG. 5). At block 702, the example classification learning controller 643 illustrated in FIG. 6 associates an example data collector 510a-c with a class. For example, the classification learning controller 643 may associate a data collector 510a-c with a class by executing an example classification model 652 (FIG. 6) using a data collector characteristic received from an example user device 520a-c (FIG. 5) corresponding to the example data collector 510a-c. In some examples, the classification model 652 is generated by applying a learning algorithm to classification training data based on data collector characteristics of a training group. At block 704, the selection generator 644 illustrated in FIG. 6 selects the class based on a requested characteristic of a task request in response to receiving the task request from a distribution agent (e.g., the distribution agent 550 of FIG. 5). At block 706, the selection generator 644 selects the data collector associated with the class. For example, the selection generator 644 selects the data collector 510a-c from the class. At block 708, the data interface 641 illustrated in FIG. 6 sends (e.g., transmits) the selection to the distribution agent 550. The program 700 ends.

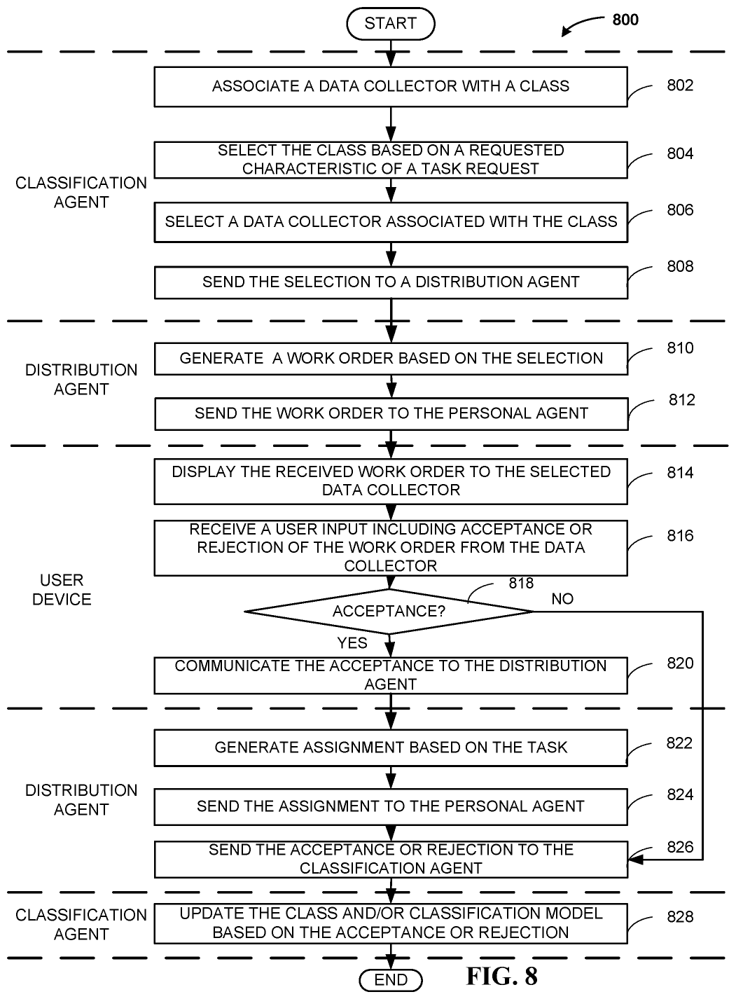

Another example flowchart representative of example programs 800 of FIG. 8 may implement the example classification agent 540 of FIGS. 5 and 6, the distribution agent 550 (FIG. 5), and the user devices 520a-c (FIG. 5) to process and assign work orders to data collectors (e.g., the data collectors 510a-c of FIG. 5). For example, as indicated in FIG. 8, different instructions of the programs 800 may be executed to implement different ones of the classification agent 540, the distribution agent 550, and the user devices 520a-c. For example, blocks 802-808 and block 828 correspond to the classification agent 540, blocks 810-812 and blocks 822-826 correspond to the distribution agent 550, and blocks 814-820 correspond to the user devices 520a-c.

At block 802, the classification learning controller 643 (FIG. 6) associates a data collector 510a-c with a class. For example, the classification learning controller 643 associates the data collector 510a-c with a class by executing a classification model 652 using a data collector characteristic received from a user device 520a-c corresponding to the data collector 510a-c. For example, if the data collector 510a lives in Boston, the classification learning controller 643 may assign the data collector 510a to a class that includes data collectors located in Boston.

At block 804, the classification learning controller 643 selects a class based on a requested characteristic of a task request. The classification learning controller 643 may select a class in response to receiving the task request from a distribution agent (e.g., the distribution agent 550 of FIG. 5). For example, if the classification agent 540 receives a task to be performed in Boston, the classification learning controller 643 may select the class of data collectors located in Boston.

At block 806, the selection generator 644 (FIG. 6) selects a data collector (e.g., one of the data collectors 510a-c) associated with the class. In some examples, the selection generator 644 may select a data collector 510a-c from a list of data collectors associated with the class. For example, the selection generator 644 may select the data collector 510a from the class of data collectors living in Boston.

At block 808, the data interface 641 sends (e.g., transmits) the selection to a distribution agent (e.g., the distribution agent 550 of FIG. 5). For example, the data interface 641 may send a selection of the data collector 510a living in Boston to the distribution agent 550.

At block 810, the distribution agent 550 illustrated in FIG. 5 generates a work order based on the selection received from the classification agent 540. At block 812, the distribution agent 550 sends (e.g., transmits) the work order to a user device 520a-c associated with the selected data collector 510a-c. For example, the distribution agent 550 may generate a work order based on the selection of the data collector 510a and send the work order to the user device 520a of the data collector 510a.

At block 814, a user device 520a-c illustrated in FIG. 5 displays the received work order to the selected data collector 510a-c. At block 816, the user device 520a-c receives a selection including acceptance or rejection of the work order from the selected data collector 510a-c. If the user device 520a-c determines that the selected data collector 510a-c rejects the work order at block 818, the user device 520a-c sends (e.g., transmits) the rejection of the work order to the classification agent 540 (block 826). For example, the user device 520a may receive a response indicative of a rejection from the selected data collector 510a and the user device 520a may transmit the rejection to the classification agent 540 illustrated in FIG. 5. If the user device 520a-c determines that the selected data collector 510a-c accepts the work order (block 818), the user device 520a-c communicates the acceptance of the work order to the distribution agent 550 (block 820). In some examples, the user device 520a-c accepts or rejects the work order automatically (e.g., without user input) based on data collector characteristics learned and/or predicted by the user device 520a-c.

At block 822, the distribution agent 550 generates an assignment based on the task request. The distribution agent 550 sends (e.g., transmits) the assignment to the user device 520a-c (block 824). In some examples, the assignment includes further details and/or instructions relating to the task, such as location, requirements, pay, expectations, and/or criteria associated with the task, and/or any other information related to the task. At block 826, the distribution agent 550 sends (e.g., transmits) the acceptance or rejection of the work order to the classification agent 540.

At block 828, the classification agent 540 (FIG. 5) updates the class of the data collector 510a-c and/or the classification model 652 based on the acceptance or rejection. For example, if the classification agent 540 receives an indication of rejection of the task located in Boston, the classification agent 540 may remove the data collector 510a from the Boston class and update the classification model 652 such that selected data collector 510a is less likely to be selected for tasks located in Boston in the future. If the classification agent 540 receives an indication of acceptance of the task, the classification agent 540 may update the classification model 652 such that the selected data collector 510a is more likely to be selected for tasks located in Boston in the future. The programs 800 of FIG. 8 end.

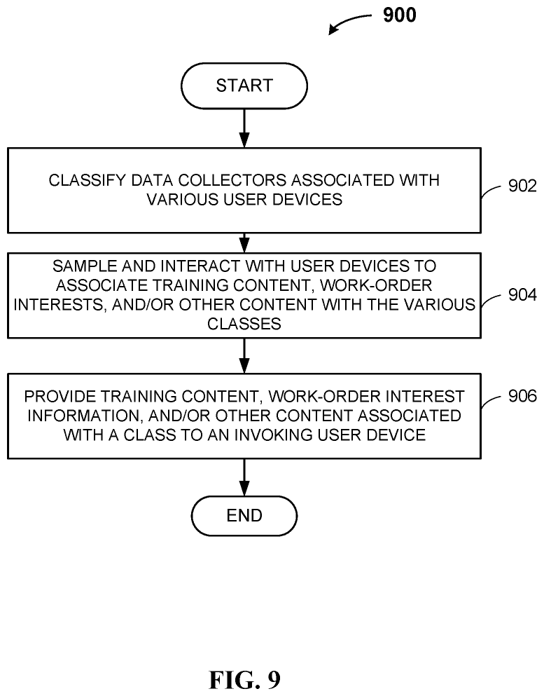

FIG. 9 is a flowchart representative of machine readable instructions which may be executed to implement the classification agent 540 of FIG. 6 to classify data and/or provide assistance to a data collector.

At block 902, the classification agent 540 classifies data collectors (e.g., the data collectors 510a-c of FIG. 5) associated with various user devices (e.g., the user device 520a-c of FIG. 5). For example, the classification agent 540 classifies the data collectors 510a-c to various classes based on data collector characteristics such as skills, skill levels, interests, geographic location, device information, or other information suitable for use in assigning tasks to the data collectors 510a-c. At block 904, the classification agent 540 engages (e.g., samples and interacts) with the user device 520a-c to associate training content, work order interests, and/or other content with various classes. In some examples, the classification agent 540 engages with the user device 520a-c at periodic or aperiodic intervals. For example, the classification agent 540 can periodically engage with the user device 520a-c. At block 906, the classification agent 540 provides training content, work order interest information, and/or other content associated with a class to an invoking user device 520a-c. For example, the classification agent 540 can provide the information to the user devices 520a-c by associating the invoking user device 520a-c with a class.

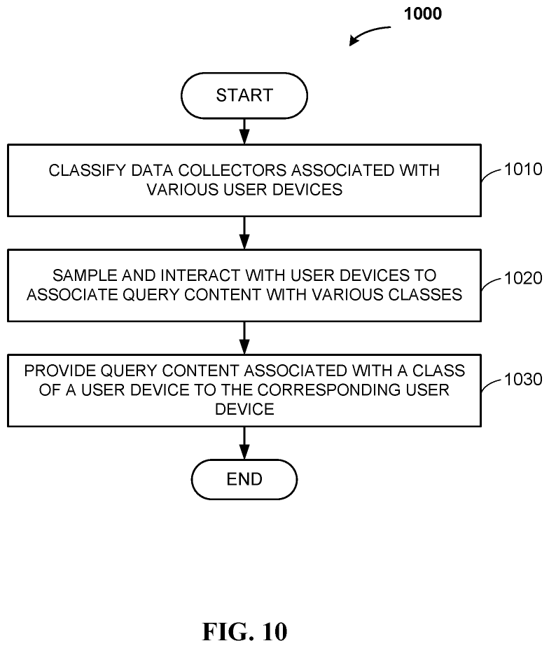

FIG. 10 is a flowchart representative of machine readable instructions which may be executed to implement the classification agent 540 of FIG. 6 to classify data and/or provide query content to a data collector.

At block 1010, the classification agent 540 classifies data collectors (e.g., the data collectors 510a-c of FIG. 5) associated with various user devices (e.g., the user devices 520a-c of FIG. 5). For example, the classification agent 540 may classify the data collectors 510a-c into various classes based on data collector characteristics such as skills, skill levels, interests, geographic location, device information, or other information suitable for use in assigning tasks to the data collectors 510a-c. At block 1020, the classification agent 540 samples and interacts with the user devices 520a-c to associate query content with various classes. For example, the classification agent 540 can sample and interact with the user devices 520a-c at periodic or aperiodic intervals. At block 1030, the classification agent 540 provides query content associated with a class of an invoking user device 520a-c to the corresponding user device 520a-c. For example, the classification agent 540 may provide query content to the user device 520a-c in response to receiving a request from the invoking user device 520a-c.

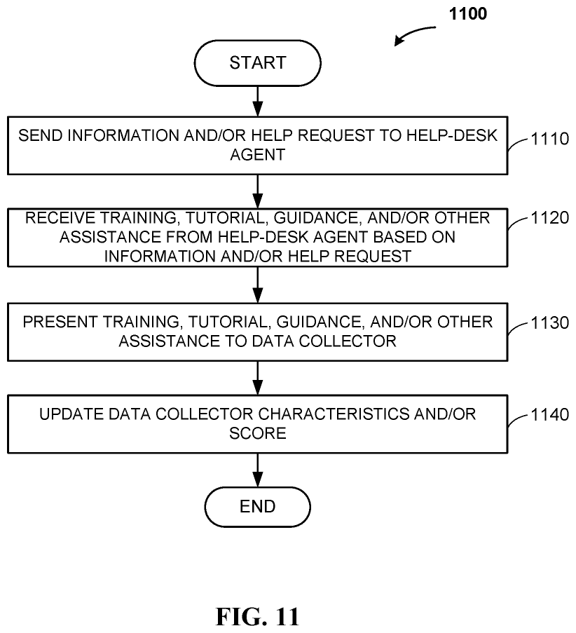

FIG. 11 is a flowchart representative of machine readable instructions which may be executed to implement the user device 520a-c illustrated in FIG. 5 to provide training and/or assistance to a data collector 510a-c (FIG. 5).

At block 1110, the user device 520a-c sends (e.g., transmits) information and/or a help request to a help desk agent (e.g., the help desk agent 530 of FIG. 5). For example, the user device 520a may transmit a request for assistance in taking photographs to the help desk agent 530. In some examples, the user device 520a may transmit device information (e.g., model, software version, or other device information) and/or device camera information (e.g., resolution, pixel size, optical or digital zoom, and/or other device camera information) to the help desk agent 530.

At block 1120, the user device 520a-c receives training, tutorials, troubleshooting, guidance, and/or other assistance (e.g., a response to the help request) from the help desk agent 530. For example, the user device 520a may receive a photography tutorial from the help desk agent 530.

At block 1130, the user device 520a-c presents the training, tutorials, troubleshooting, guidance, and/or other assistance to the data collector 510a-c. For example, the user device 520a may present the photography tutorial to the data collector 510a.

At block 1140, the user device 520a-c updates data collector characteristics and/or a data collector score. The user device 520a-c may perform the updates of block 1140 based on completion of the training, tutorials, troubleshooting, or other form(s) of assistance. For example, the user device 520a may update the photography skill level and/or a photography skill level score of the data collector 510a based on completion of the photography tutorial.

FIG. 12 is a block diagram of an example processor platform 1200 structured to execute the instructions of FIGS. 7-10 to implement the example classification agent 540 of FIGS. 5 and 6. A substantially similar or identical processor platform may be used to implement the help desk agent 530 and/or the distribution agent 550 of FIG. 5. The processor platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset or other wearable device, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors, GPUs, DSPs, or controllers from any desired family or manufacturer. The hardware processor may be a semiconductor-based (e.g., silicon-based) device. In this example, the processor 1212 implements the example classification algorithms 342 and 442, the example preferential learning (score computation) algorithms 344 and 426, the relevance ranking an scoring algorithms 444, and the example collaborative algorithms 346 and 446 of FIGS. 3 and 4 and the example data interface 641, the example parser 642, the example classification learning controller 643, the example selection generator 644, the example model trainer 646, the example model executor 647, and/or the classification model 652 of the example classification agent 540 of FIG. 6.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1216 may be implemented by flash memory and/or any other desired type of memory device. Access to the main memory 1214, 1216 is controlled by a memory controller. The example memory 645 of the example classification agent 540 illustrated in FIG. 6 can be implemented by the volatile memory 1214, the non-volatile memory 1216, and/or the one or more mass storage devices 1228.

The processor platform 1200 of the illustrated example also includes an interface circuit 1220. The interface circuit 1220 may be implemented by any type of interface standard, such as an Ethernet interface, a universal serial bus (USB), a Bluetooth® interface, a near field communication (NFC) interface, and/or a PCI express interface.

In the illustrated example, one or more input devices 1222 are connected to the interface circuit 1220. The input device(s) 1222 permit(s) a user to enter data and/or commands into the processor 1212. The input device(s) 1222 can be implemented by, for example, an audio sensor, a microphone, a camera (still or video), a keyboard, a button, a mouse, a touchscreen, a track-pad, a trackball, isopoint and/or a voice recognition system.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1220 of the illustrated example, thus, typically includes a graphics driver card, a graphics driver chip and/or a graphics driver processor.

The interface circuit 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1226. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, redundant array of independent disks (RAID) systems, and digital versatile disk (DVD) drives.

Example machine executable instructions 1232 represented in FIGS. 7-10 may be stored in the mass storage device 1228, in the volatile memory 1214, in the non-volatile memory 1216, and/or on a removable non-transitory computer readable storage medium such as a CD or DVD.

FIG. 13 is a block diagram of an example processor platform 1300 structured to execute the instructions of FIG. 11 to implement the example personalized user agents 120 (FIGS. 1 and 2), 320 (FIG. 3), and/or 420 (FIG. 4), and/or the example user devices 520a-c (FIG. 5). The processor platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset or other wearable device, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors, GPUs, DSPs, or controllers from any desired family or manufacturer. The hardware processor may be a semiconductor-based (e.g., silicon-based) device. In this example, the processor 1312 implements the example personal learning controllers 332 and 432 (FIGS. 3 and 4), the example personal model trainers 328 and 428 (FIGS. 3 and 4), the example personal model executors 330 and 430 (FIGS. 3 and 4), the example chatbot applications 322 and 422 (FIGS. 3 and 4), the example natural language understanding algorithms 324 and 424 (FIGS. 3 and 4), and the example preferential learning (score computation) algorithms 326 and 426 (FIGS. 3 and 4) of the example personalized user agents 320 and 420 of FIGS. 3 and 4.

The processor 1312 of the illustrated example includes a local memory 1313 (e.g., a cache). The processor 1312 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a universal serial bus (USB), a Bluetooth® interface, a near field communication (NFC) interface, and/or a PCI express interface.

In the illustrated example, one or more input devices 1322 are connected to the interface circuit 1320. The input device(s) 1322 permit(s) a user to enter data and/or commands into the processor 1312. The input device(s) 1322 can be implemented by, for example, an audio sensor, a microphone, a camera (still or video), a keyboard, a button, a mouse, a touchscreen, a track-pad, a trackball, isopoint and/or a voice recognition system.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1320 of the illustrated example, thus, typically includes a graphics driver card, a graphics driver chip and/or a graphics driver processor.

The interface circuit 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1326. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, redundant array of independent disks (RAID) systems, and digital versatile disk (DVD) drives.

Example machine executable instructions 1332 represented in FIG. 11 may be stored in the mass storage device 1328, in the volatile memory 1314, in the non-volatile memory 1316, and/or on a removable non-transitory computer readable storage medium such as a CD or DVD.

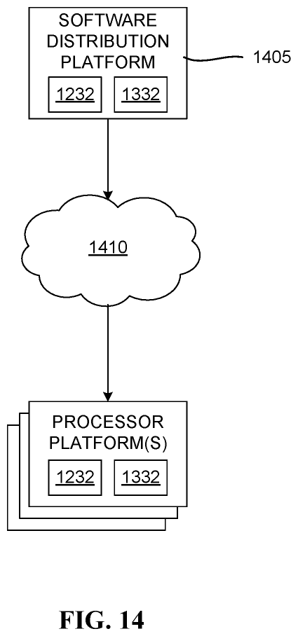

A block diagram of an example software distribution platform 1405 to distribute software such as the example computer readable instructions 1232 of FIGS. 7-10 and/or the example computer readable instructions 1332 of FIG. 11 to third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 1232 of FIGS. 7-10 and/or the example computer readable instructions 1332 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the computer readable instructions 1232 of FIGS. 7-10 and/or the computer readable instructions 1332 of FIG. 11, as described above. The one or more servers of the example software distribution platform 1405 are in communication with a network 1410, which may correspond to any one or more of the Internet and/or any of the example networks 1226 (FIG. 12) and/or 1336 (FIG. 13) described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 1232 of FIGS. 7-10 and/or the computer readable instructions 1332 of FIG. 11 from the software distribution platform 1405. For example, the software, which may correspond to the example computer readable instructions 1232 of FIGS. 7-10 and/or the example computer readable instructions 1332 of FIG. 11, may be downloaded to the example processor platform 1200, which is to execute the computer readable instructions 1232 to implement the example classification agent 540 of FIG. 6, and/or to the example processor platform 1300, which is to execute the computer readable instructions 1332 to implement the example personalized user agents 120 (FIG. 1), 320 (FIG. 3), 420 (FIG. 4) and/or the example user devices 520a-c (FIG. 5). In some examples, one or more servers of the software distribution platform 1405 periodically offer, transmit, and/or force updates to the software (e.g., the example computer readable instructions 1232 of FIGS. 7-10 and/or the example computer readable instructions 1332 of FIG. 11) to ensure improvements, patches, updates, etc. are distributed and applied to the software at the end user devices.

The disclosed methods, apparatus and articles of manufacture improve the efficiency of using a computing device by using artificial intelligence/machine learning to learn characteristics of data collectors and automatically assign tasks to data collectors based on the learned characteristics. The disclosed methods, apparatus and articles of manufacture are accordingly directed to one or more improvement(s) in the functioning of a computer.

In some examples, an example apparatus includes a classification learning controller to associate a data collector with a class by executing a classification model using a first data collector characteristic, the first data collector characteristic corresponding to the data collector, the classification model generated by applying a learning algorithm to classification training data, the classification training data including second data collector characteristics of a training group; a selection generator to select the class based on a requested characteristic of a task request from a distribution agent and select the data collector associated with the class; and a data interface to send the selection to the distribution agent.

In some examples, the first data collector characteristic includes at least one of a skill level of the data collector, a performance rating of the data collector, one or more interests of the data collector, a location of the data collector, or device information of the data collector.

In some examples, the learning algorithm is at least one of a classification algorithm, a preferential learning algorithm, a relevance ranking and scoring algorithm, or a collaborative algorithm.

In some examples, the classification learning controller is to update the classification model based on an acceptance or rejection of the task request.

In some examples, the apparatus includes a personalized user agent, the personalized user agent including a personal learning controller to accept or reject the task request by executing a personal model, the personal model generated by applying a personal learning algorithm to personal training data based on first user input.

In some examples, the personal learning algorithm associated with the personal learning controller is at least one of a natural language understanding algorithm, a preferential learning algorithm, or a relevance ranking and scoring algorithm.

In some examples, the personalized user agent periodically engages the data collector by prompting the data collector to provide second user input and updates the personal model based on the second user input.

In some examples, the task request includes at least one of a request to capture a photograph, log data, write a description, or answer a questionnaire.

In some examples, a non-transitory computer readable medium includes computer readable instructions that, when executed, cause at least one processor to at least associate a data collector with a class by executing a classification model using a first data collector characteristic, the first data collector characteristic corresponding to the data collector, the classification model generated by applying a learning algorithm to classification training data, the classification training data including second data collector characteristics of a training group; select the class based on a requested characteristic of a task request from a distribution agent; select the data collector associated with the class; and transmit the selection to the distribution agent.

In some examples, the first data collector characteristic includes at least one of a skill level of the data collector, a performance rating of the data collector, one or more interests of the data collector, a location of the data collector, or device information of the data collector.

In some examples, the learning algorithm is at least one of a classification algorithm, a preferential learning algorithm, a relevance ranking and scoring algorithm, or a collaborative algorithm.

In some examples, the computer readable instructions are further to cause the at least one processor to update the classification model based on an acceptance or rejection of the task request.

In some examples, the task request includes at least one of a request to capture a photograph, log data, write a description, or answer a questionnaire.

In some examples, a method includes associating, by executing an instruction with a processor, a data collector with a class by executing a classification model using a first data collector characteristic, the first data collector characteristic corresponding to the data collector, the classification model generated by applying a learning algorithm to classification training data, the classification training data including second data collector characteristics of a training group; in response to receiving a task request from a distribution agent, selecting, by executing an instruction with the processor, the class based on a requested characteristic of the task request; selecting, by executing an instruction with the processor, the data collector associated with the class; and sending, by executing an instruction with the processor, the selection to the distribution agent.

In some examples, the first data collector characteristic includes at least one of a skill level of the data collector, a performance rating of the data collector, one or more interests of the data collector, a location of the data collector, or device information of the data collector.

In some examples, the learning algorithm is at least one of a classification algorithm, a preferential learning algorithm, a relevance ranking and scoring algorithm, or a collaborative algorithm.

In some examples, the method includes updating the classification model based on an acceptance or rejection of the task request.

In some examples, the task request includes at least one of a request to capture a photograph, log data, write a description, or answer a questionnaire.

In some examples, the method includes accepting or rejecting, by a personalized user agent, the task request by executing a personal model, the personal model generated by applying a personal learning algorithm to personal training data based on first user input.

In some examples, the personalized user agent updates the personal model based on second user input.

In some examples, the personal learning algorithm is at least one of a natural language understanding algorithm, a preferential learning algorithm, or a relevance ranking and scoring algorithm.

In some examples, the personalized user agent periodically engages the data collector by prompting the data collector to provide user input.

In some examples, the personalized user agent periodically engages the data collector using a chatbot.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus, comprising:
classification learning controller circuitry to associate a data collector with a class by executing a classification model using a first data collector characteristic, the first data collector characteristic corresponding to the data collector, the classification model generated by applying a learning algorithm to classification training data, the classification training data including second data collector characteristics of a training group;
selection generator circuitry to:
select the class based on a requested characteristic of a task request from a distribution agent; and
select the data collector associated with the class; and
data interface circuitry to send the selection to the distribution agent.

2. The apparatus of claim 1, wherein the first data collector characteristic includes at least one of a skill level of the data collector, a performance rating of the data collector, one or more interests of the data collector, a location of the data collector, or device information of the data collector.

3. The apparatus of claim 1, wherein the learning algorithm is at least one of a classification algorithm, a preferential learning algorithm, a relevance ranking and scoring algorithm, or a collaborative algorithm.

4. The apparatus of claim 1, wherein the classification learning controller circuitry is to update the classification model based on an acceptance or rejection of the task request.

5. The apparatus of claim 1, including a personalized user agent, the personalized user agent including personal learning controller circuitry to accept or reject the task request by executing a personal model, the personal model generated by applying a personal learning algorithm to personal training data based on first user input.

6. The apparatus of claim 5, wherein the personal learning algorithm associated with the personal learning controller circuitry is at least one of a natural language understanding algorithm, a preferential learning algorithm, or a relevance ranking and scoring algorithm.

7. The apparatus of claim 5, wherein the personalized user agent periodically engages the data collector by prompting the data collector to provide second user input and updates the personal model based on the second user input.

8. The apparatus of claim 1, wherein the task request includes at least one of a request to capture a photograph, log data, write a description, or answer a questionnaire.

9. A non-transitory computer readable medium comprising computer readable instructions that, when executed, cause at least one processor to at least:
associate a data collector with a class by executing a classification model using a first data collector characteristic, the first data collector characteristic corresponding to the data collector, the classification model generated by applying a learning algorithm to classification training data, the classification training data including second data collector characteristics of a training group;
select the class based on a requested characteristic of a task request from a distribution agent;
select the data collector associated with the class; and
transmit the selection to the distribution agent.

10. The non-transitory computer readable medium of claim 9, wherein the first data collector characteristic includes at least one of a skill level of the data collector, a performance rating of the data collector, one or more interests of the data collector, a location of the data collector, or device information of the data collector.

11. The non-transitory computer readable medium of claim 9, wherein the learning algorithm is at least one of a classification algorithm, a preferential learning algorithm, a relevance ranking and scoring algorithm, or a collaborative algorithm.

12. The non-transitory computer readable medium of claim 9, wherein the computer readable instructions are further to cause the at least one processor to update the classification model based on an acceptance or rejection of the task request.

13. The non-transitory computer readable medium of claim 9, wherein the task request includes at least one of a request to capture a photograph, log data, write a description, or answer a questionnaire.

14. A method, comprising:
associating, by executing an instruction with a processor, a data collector with a class by executing a classification model using a first data collector characteristic, the first data collector characteristic corresponding to the data collector, the classification model generated by applying a learning algorithm to classification training data, the classification training data including second data collector characteristics of a training group;
in response to receiving a task request from a distribution agent, selecting, by executing an instruction with the processor, the class based on a requested characteristic of the task request;
selecting, by executing an instruction with the processor, the data collector associated with the class; and
sending, by executing an instruction with the processor, the selection to the distribution agent.

15. The method of claim 14, wherein the first data collector characteristic includes at least one of a skill level of the data collector, a performance rating of the data collector, one or more interests of the data collector, a location of the data collector, or device information of the data collector.

16. The method of claim 14, wherein the learning algorithm is at least one of a classification algorithm, a preferential learning algorithm, a relevance ranking and scoring algorithm, or a collaborative algorithm.

17. The method of claim 14, further including updating the classification model based on an acceptance or rejection of the task request.

18. The method of claim 14, wherein the task request includes at least one of a request to capture a photograph, log data, write a description, or answer a questionnaire.

19. The method of claim 14, including accepting or rejecting, by a personalized user agent, the task request by executing a personal model, the personal model generated by applying a personal learning algorithm to personal training data based on first user input.

20. The method of claim 19, wherein the personalized user agent updates the personal model based on second user input.

21. The method of claim 19, wherein the personal learning algorithm is at least one of a natural language understanding algorithm, a preferential learning algorithm, or a relevance ranking and scoring algorithm.

22. The method of claim 19, wherein the personalized user agent periodically engages the data collector by prompting the data collector to provide user input.

23. The method of claim 19, wherein the personalized user agent periodically engages the data collector using a chatbot.
